(19) United States
(12) Patent Application Publication
(10) Pub. No.: US 2002/0000487 A1
(43) Pub. Date: Jan. 3, 2002

(54) Seat belt retractor

(76) Inventors: Tetsuya Hamaue, Tokyo (JP); Hiroki Takehara, Tokyo (JP); Hikaru Kameyoshi, Tokyo (JP)

Correspondence Address: Howard N. Shipley, FOLEY & LARDNER, Washington Harbour, 3000 K Street, N.W., Suite 500, Washington, DC, 20007-5109, US

(21) Appl. No.: 09/837,372

(22) Filed: Apr. 19, 2001

(30) Foreign Application Priority Data
Apr. 19, 2000 (JP) 2000-118001

(51) Int. Cl. B60R 22/46

(52) U.S. Cl. 242/374

(57) ABSTRACT

A seat belt device with a pretensioner which effectively transmits gas pressure to a ring gear in order to provide a large pretensioning force is provided. A piston is pushed by the pressure of gas provided by a gas generator. The force on the piston is transmitted to balls and the front-most ball exerts force on an external tooth of a ring gear. As a result, pins are sheared so as to release the ring gear. The ring gear moves because the ball exerts force on the ring gear. The internal teeth of the ring gear are meshed with the external teeth of the pinion. The ring gear and the pinion rotate together to pretension a seat belt. Lubricant is applied to the inner surface of the pipe or the outer surfaces of the balls, so that gas pressure can be effectively transmitted to the ring gear.

### BACKGROUND OF THE INVENTION

The present invention relates to a seat belt retractor with a pretensioner. More particularly, the present invention relates to a seat belt retractor with a pretensioner that includes balls positioned in a pipe.

A passenger car is normally equipped with seat belt devices for protecting occupants when the car experiences an abrupt deceleration. Such a seat belt device may include a pretensioner which takes up a seat belt around an occupant to restrain the occupant with increased forces when an accident such as a vehicle collision is detected.

There are various types of pretensioners. One known type of pretensioner comprising a pipe, a gas generator disposed on one end of the pipe, a piston arranged in the pipe, and balls arranged within the pipe. Typically, the balls are moved by the piston as a result of gas pressure produced by the gas generator. The balls are discharged through an outlet disposed at the other end of the pipe, and a pretensioner gear and a gear connected to a spool are meshed with each other and rotated by the balls being discharged, thereby pretensioning a seat belt.

A significant problem in pretensioners of this type is that force created by gas pressure is absorbed by friction between the inner wall of the pipe and the balls, thus reducing force to be transmitted to the gear. Therefore, in order to obtain large pretensioning force, previous device had a large configuration. The large device creates additional problems, because it is difficult to install a large retractor in a passenger car.

### SUMMARY OF THE INVENTION

The present invention was made taking the aforementioned circumstances into consideration and the object of this invention is to provide a seat belt retractor with a pretensioner which can effectively transmit gas pressure produced form a gas generator to a gear, in order to obtain large pretensioning force, without requiring a retractor of increased size.

The aforementioned object is achieved according to the present invention by providing a seat belt retractor with a pretensioner of a type comprising a pipe, a gas generator disposed on one end of the pipe, a piston arranged in the pipe, and balls arranged within the pipe, in which the balls are moved via the piston by gas pressure produced by the gas generator and are discharged through an outlet disposed at the other end of the pipe, and a pretensioner gear and a gear connected to a spool are meshed with each other and rotated by the balls being discharged, thereby pretensioning a seat belt, the seat belt retractor being characterized in that lubricant of a type forming a dry lubricating film is applied to at least either the inner surface of said pipe or the outer surfaces of said balls.

According to the present invention, since the lubricant of a type forming a dry lubricating film is applied to at least either the inner surface of the pipe or the outer surfaces of the balls, the friction resistance between the inner surface of a pipe and balls can be reduced, thereby effectively transmitting gas pressure produced by the gas generator to a seat belt retracting mechanism. Further, since the lubricant is not of a wet type, there is no possibility of the lubricant leaking out and of thus causing a trouble.

According to the present invention, the dry coating lubricant may include a rust preventing property in addition to the lubricating property. Because the seat belt retractor is used over a long term of years, the pipe and the balls should be treated with a rust-preventive process. Since the dry coating lubricant has rust preventing property besides its lubricating property, the rust-preventive process and the lubrication process can be done simultaneously, thereby simplifying the manufacturing process.

As an alternative, grease may be employed instead of the dry lubricant. As mentioned above, when lubricant of a wet type is used, there is normally some concern that the lubricant will leak and thus causes a problem. However, if there is no possibility of such trouble, grease can exhibit the same effect as the dry coating lubricant.

According to the present invention, preferably, the lubricant is of a type capable of exhibiting its performance enough even at a temperature higher than 100° C. Since the temperature of the gas produced at the start of the pretensioner is very high, the temperature of the balls may become 100° C. or more. Even in such a case, gas pressure produced by the gas generator can be effectively transmitted to a seat belt retracting mechanism.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a sectional view showing an example of structures of a pretensioner.

FIGS. 2(1)-2(4) are views showing the operation of the pretensioner shown in FIG. 1.

FIG. 3 is an exploded perspective view showing an example of a seat belt retractor having the pretensioner.

### DETAILED DESCRIPTION

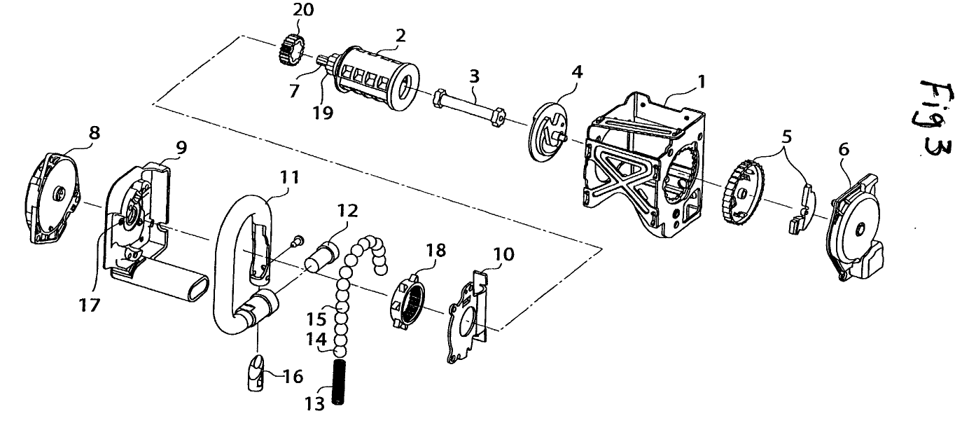

FIG. 3 is an exploded perspective view showing a seat belt retractor with a ball type pretensioner. This seat belt retractor comprises a base frame 1, a spool 2 housed in the base frame 1, and a seat belt (not shown) wound onto the spool 2. Therefore, the rotation of the spool 2 causes the winding and unwinding of the seat belt. The spool 2 has a torsion bar 3 as its shaft, one end of the torsion bar 3 is supported in a retainer 6 via two locking mechanisms 4, 5.

The spool 2 has a gear 7 on one end thereof. The spool gear 2 meshes with a gear in a return spring cover 8. As a result, the spool 2 is biased in a belt-winding direction by a return spring in the return spring cover 8.

The seat belt retractor having the aforementioned structure is provided with a pretensioner. Hereinafter, the structure of the pretensioner will be described. The pretensioner comprises a pipe 11 between a pretensioner cover 9 and a pretensioner plate 10, and a gas generator 12 disposed on end of the pipe 11. Arranged inside the pipe 11 are a stopper spring 13, a piston 14, and a plurality of balls 15. The pipe 11 has a cut-out in a peripheral portion near the other end thereof and a guide block 16 is fitted into the other end of the pipe 11.

The pretensioner cover 9 is provided with two pins 17 by which a ring gear 18 (i.e., “the pretensioner gear”) is held. The front-most ball 15a is supported between one of the external teeth of the ring gear 18 and a portion of the inner wall of the pipe 11 facing to the cut-out.

On the other hand, a pinion 20 (i.e., “the gear connected to the spool”) is arranged to be connected to the gear 19 of the spool 2. In the normal state, the ring gear 18 and the pinion 20 are not meshed with each other. When gas is produced by the gas generator 12, however, the balls 15 are pushed via the piston 14 by the pressure of gas so that the pins 17 are sheared by forces from the balls, whereby the ring gear 18 is released to be free and thus moves to be meshed with the pinion 20, as will be described in detail later. The ring gear 18 in this state is forced to be rotated by the balls 15 so as to rotate the spool 2 via the pinion 20. In this manner, the seat belt is pretensioned.

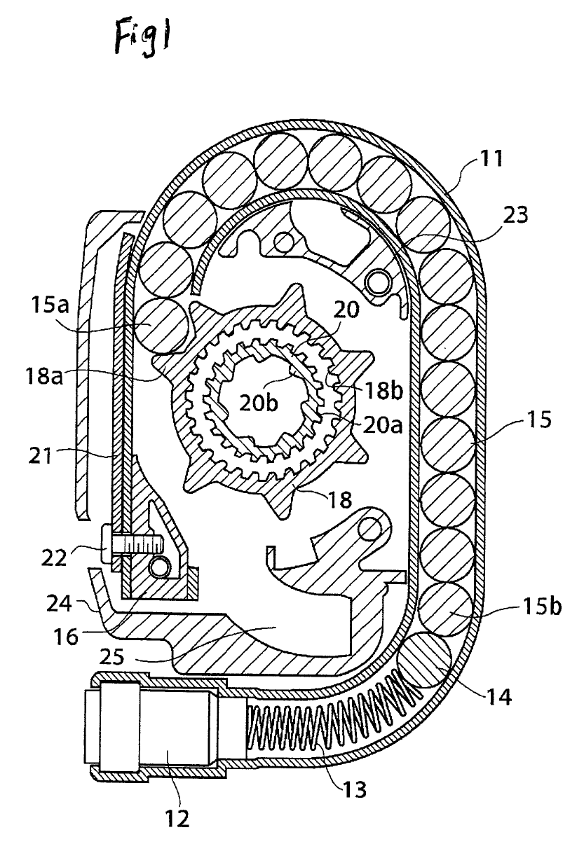

FIG. 1 is a sectional view showing an embodiment of the pretensioner according to the present invention. The front-most ball 15a is stopped by one of external teeth 18a of the ring gear 18 held by the pins 17 shown in FIG. 3. Other balls 15 are retained in the pipe 11 because the front-most ball 15a is stopped. The piston 14 is spherical and is in contact with the rear-most ball 15b. The piston 14 is biased by the spring 13 so as to press the balls 15 toward the front end. Preferably, the balls 15 are made of steel and the piston 14 is made of silicone resin.

The pipe 11 has a cut-out formed in a portion near the outlet of the balls 15, in which a portion of the ring gear 18 is positioned. Fitted in the front end of the pipe 11 is a guide block 16, preferably made of aluminum. The guide block 16 is fixed to a supporting plate 21 by a vise 22. It should be noted that the vise 22 also has the function of fixing the pipe 11 to the supporting plate 21. Numeral 23, 24 designate sections of the pretensioner cover 9. The section 23 positions the pipe 11 and the section 24 forms a ball receiving portion 25.

In this state, the ring gear 18 is held by the pins 17 shown in FIG. 3, the internal teeth 20b of the pinion 20 are fitted into the gear 19 of the spool 2, and the internal teeth 18b of the ring gear 18 are meshed with none of the external teeth 20a of the pinion 20. Therefore, the pretensioner in this state has no effect on the rotation of the spool.

As gas is produced by the gas generator 12, the piston 14 is pushed by the pressure of gas. The force on the piston 14 is transmitted to the balls 15 so that the front-most ball 15a exerts force on the external tooth 18a of the ring gear 18. As a result of this, the pins 17 shown in FIG. 3 are sheared so as to release the ring gear 18. Therefore, the ring gear 18 moves to the lower right in FIG. 1 because the ball 15 exerts force on the ring gear 18 to the lower right direction. This movement brings the internal teeth 18b of the ring gear 18 to be meshed with the external teeth 20a of the pinion 20.

In this condition, a space is created between the inner surface of the pipe 11 and each bottom between the adjacent external teeth 18a of the ring gear 18 through which the ball 15 can pass. The pushed ball 15 passes through the space while rotating the ring gear 18, and falls down to the ball receiving portion 25. Then, the next ball 15 presses another external tooth 18a of the ring gear 18 so as to further rotate the ring gear 18, and falls down to the ball receiving portion 25. The guide block 16 is provided to maintain the distance between the guide block 16 and the bottoms of the ring gear 18 slightly greater than the diameter of the balls 15. That is, the guide block 16 has the function of enlarging the range in which the balls 15 and the ring gear 18 are in contact.

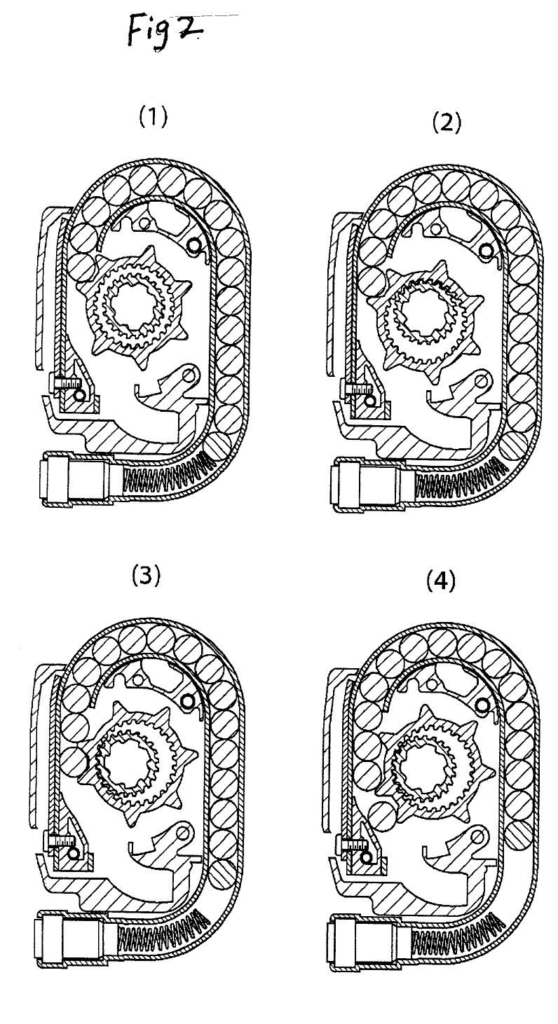

The aforementioned actions are shown in FIGS. 2(1)-2(4). FIG. 2(1) illustrates the initial state. FIG. 2(2) illustrate the state where the pins 17 are sheared to release the ring gear so that the internal teeth 18b of the ring gear and the external teeth 20a of the pinion 20 are meshed. FIGS. 2(3), 2(4) illustrate the state where the ring gear 18 and the pinion 20 are rotated by pushing force of the balls.

Hereinafter, a preferred embodiment of the present invention will be described with reference to FIG. 1. Lubricant of a type forming a dry lubricating film (hereinafter, referred to as “dry coating lubricant”) is sprayed to the inner surface of the pipe 11 and the outer surfaces of the balls 15 shown in FIG. 1. Preferably, a molybdenum coating should be employed as the lubricant. As an example of the dry coating lubricant, Solvest® of a type forming a dry lubricating film available from SST INC. is preferably used. Since this lubricant has rust preventing property besides the lubricating property, the use of this lubricant can eliminate the rust-preventive process such as plating. In addition, since the lubricant has a wide usable temperature range from −200° C. to 500° C., the lubricant can exhibit its performance enough even when the pipe 11 and the balls 15 are heated to a high temperature by gas produced by the gas generator 12.

If melting of grease causes no trouble because of a specific structure of the pretensioner, grease can be employed instead of the dry coating lubricant.

As described above, according to the present invention, the friction resistance between the inner surface of a pipe and balls can be reduced, thereby effectively transmitting gas pressure produced by a gas generator to a seat belt retracting mechanism and thus achieving a compact retractor. Since the lubricant is not of a wet type, there is no possibility of the lubricant leaking out and of thus causing a trouble.

In an aspect according to the present invention, the rust-preventive process and the lubrication process can be done simultaneously, thereby simplifying the manufacturing process.

In an aspect according to the present invention, even when the pipe and/or the balls become hot due to the temperature of gas, gas pressure produced by the gas generator can be effectively transmitted to a seat belt retracting mechanism.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

The priority document Japanese Patent Application No. 2000-118001, filed Apr. 19, 2000 is hereby incorporated by reference herein in its entirety.

What is claimed is:

1. A seat belt retractor including a pretensioner, the retractor comprising:
a pipe;
a gas generator disposed on one end of the pipe;
a piston arranged in the pipe; and
a plurality of balls arranged in the pipe;
wherein the balls are configured to be moved by the piston as a result of gas pressure produced by the gas generator, and
wherein the balls are configured to be discharged through an outlet disposed at the other end of the pipe, and
wherein a pretensioner gear and a gear connected to a spool are configured to mesh together when the balls are discharged from the pipe and to rotate in response to the balls being discharged, thereby pretensioning a seat belt;
wherein a lubricant is positioned between the balls and the pipe.

2. The seat belt retractor of claim 1, wherein said lubricant comprises a dry lubricating film.

3. The seat belt retractor of claim 2, wherein said lubricating film is located on an inner surface of the pipe.

4. The seat belt retractor of claim 2, wherein said lubricating film is located on an outer surface of each of the plurality of balls.

5. The seat belt retractor of claim 1, wherein said lubricant has a rust preventing property.

6. The seat belt retractor of claim 1, wherein said lubricant comprises grease.

7. The seat belt retractor of claim 1, wherein said lubricant provides lubrication between the balls and the pipe when the temperature of the balls exceeds 100° C.
